(19) United States
(12) Patent Application Publication
(10) Pub. No.: US 2005/0146719 A1
(43) Pub. Date: Jul. 7, 2005

(54) Method and apparatus for illuminating a substrate during inspection

(76) Inventors: Rajeshwar Chhibber, San Jose, CA (US); David Willenborg, Pleasanton, CA (US)

Correspondence Address: FERNANDEZ & ASSOCIATES LLP, 1047 EL CAMINO REAL, SUITE 201, MENLO PARK, CA, 94025, US

(21) Appl. No.: 10/984,517

(22) Filed: Nov. 8, 2004

(30) Foreign Application Priority Data
Sep. 26, 2003 (WO) PCT/US03/31071

(51) Int. Cl. G01J 4/00

(52) U.S. Cl. 356/370

(57) ABSTRACT

Projection of a light field on a semiconductor wafer, the light field having uniform intensity and a predefined area. An aperture is placed within a light beam path, with a specifically designed three-dimensional profile, so as to shape the light beam in a specific manner. When this light beam is transmitted through the appropriate optics, its shape is altered so as to be projected onto the wafer as a circle (or any other desired shape). An optical mask is also employed, with a varying light attenuation to impart a varying intensity to the light path. The aperture shapes the light path, and the optical mask selectively attenuates it, in so that the end result is a uniformly-intense light field that illuminates only a specific predefined area of the wafer. Wafers can thus be illuminated while avoiding undesirable areas such as wafer edges, thus preventing over- or under-illumination.

This application claims priority to International Application Number PCT/US2003/031071, which was filed on 26 Sep. 2003, and which in turn claims priority to U.S. Provisional Patent Application No. 60/414,511, which was filed on 27 Sep. 2002, and U.S. patent application Ser. No. 10/672,056, which was filed on 25 Sep. 2003.

### BRIEF DESCRIPTION OF THE INVENTION

This invention relates to optical inspection of substrates. More specifically, this invention relates to the illumination of substrates during optical inspection.

### BACKGROUND OF THE INVENTION

As pressure to increase chip performance causes semiconductor line widths to shrink, semiconductor wafer yield losses are increasing due to pattern defects. Pattern defects, such as pattern misregistration, extra features, and missing features in patterns, can vary in size. Defects of approximately 0.035 um and above can be detected by known optical imaging methods, depending on factors such as the presence of patterns. Smaller pattern defects can be detected using slower, more expensive, more complex electron beam imaging systems, but where possible, optical systems are preferred.

Optical inspection systems typically operate by directing an angled light beam onto a semiconductor wafer or other substrate. Most of this light reflects off the wafer in a predictable direction and is removed, but some light rays fall upon surface irregularities, such as defects, and are scattered and detected. In this way, intense light can be used to increase the scatter signal, but since most of the illumination is simply reflected and absorbed, the scattered light intensity is enhanced. An analysis of this scattered light thus highlights the location and size of defects. Such systems suffer from certain drawbacks, however. For example, optical inspection systems typically direct light beams at an angle to the substrate, so as to best illuminate defects. However, it is difficult to project a light beam at an angle while still generating a circular illumination field on the substrate, so as to illuminate the wafer up to its edges, but not beyond. Illumination beyond the wafer edge is problematic, as it can cause light to scatter with high intensity, masking scattered light from defects. Typical light beams are generated with circular cross-sections, which illuminate substrates in an elliptical pattern, as shown in FIG. 1. Here, a light beam with a circular cross-section 1 is projected onto a wafer 6. However, when cast at an angle, as is typical, this circular cross-section creates an elliptical light field 3. In doing so, the edges 4 of the wafer 6 are illuminated, where fabrication irregularities result in excessive scatter and correspondingly poor defect detection. Such edge illumination is often difficult to control, especially when illumination systems with multiple reflectors and/or lenses are employed.

In addition, optical inspection systems often cast light fields having nonuniform intensities. Such nonuniform intensities can result in excessive scatter in areas of high intensity, and insufficient scatter in areas of low intensity, creating areas of lower defect sensitivity and making it difficult for current inspection tools to adjust to multiple such varying areas simultaneously. For example, observers of the elliptical light field 3 will note that it will be brighter (i.e., the light field will have a greater intensity) at areas closer to the light source 5, and dimmer (lower intensity) at areas farther from the light source 5.

Accordingly, in the field of optical inspection, it is desirable to develop illumination systems capable of illuminating a predetermined area of a wafer surface, with sharp edge cutoff, so as to prevent excessive scatter from edge irregularities. More specifically, it is desirable to illuminate predefined areas of a wafer, so that only inspected areas are illuminated, and problematic areas such as wafer edges are avoided or the amount of light cast on such areas is reduced. It is further desirable to illuminate these areas with light fields of uniform intensity, so as to prevent over-illumination in some areas and under-illumination in others.

### SUMMARY OF THE INVENTION

The invention can be implemented in numerous ways, including as a method, system, and device. Various embodiments of the invention are discussed below.

As an optical inspection system, one embodiment of the invention comprises a light source configured to emit light along an illumination path so as to facilitate optical inspection of a surface of a semiconductor wafer. The invention also includes a reflector configured to reflect the illumination path onto the semiconductor wafer. An optically opaque filter is placed in the illumination path between the light source and the reflector, this filter having an aperture shaped so as to pass a portion of the light along the illumination path on to the reflector so as to generate a predefined illuminated area on the surface of the semiconductor wafer.

As an apparatus for shaping a light path in an optical inspection system, another embodiment of the invention comprises an optically opaque body configured for placement within a light path of an optical inspection system and at an incidence angle relative to the light path. The optically opaque body has a raised portion, and an aperture within the raised portion. This aperture has a generally semicircular profile when viewed along an axis that intersects the light path at the incidence angle, the generally semicircular profile configured to shape the light path so as to facilitate the illumination of a predefined portion of a surface of a semiconductor wafer when the opaque body is placed within the light path at the incidence angle.

As an optical inspection system another embodiment of the invention comprises a light source configured to emit a light beam so as to facilitate optical inspection of a surface of a semiconductor wafer. Also included is a means for shaping the light beam so as to illuminate a predefined area of the surface of the semiconductor wafer, the predefined area illuminated to a substantially uniform intensity.

As a method of illuminating a semiconductor wafer for inspection another embodiment of the invention comprises generating a light beam having a cross-sectional profile, the light beam having a nonuniform intensity across the cross-sectional profile. The generated light beam is reflected so as to project a light field upon a semiconductor wafer, the light field having a predetermined shape and a generally uniform intensity.

Other aspects and advantages of the invention will become apparent from the following detailed description taken in conjunction with the accompanying drawings which illustrate, by way of example, the principles of the invention.

### BRIEF DESCRIPTION OF THE DRAWINGS

For a better understanding of the invention, reference should be made to the following detailed description taken in conjunction with the accompanying drawings, in which:

FIG. 1 illustrates the illumination of a wafer in accordance with the prior art.

FIG. 2 illustrates an optical inspection system configured in accordance with embodiments of the present invention.

FIGS. 3A-3B illustrate diagrammatic isometric and side views, respectively, of details of a light path within the optical inspection system of FIG. 2, including an aperture configured in accordance with embodiments of the present invention.

FIG. 3C illustrates a close-up view of an aperture as used within the light path.

FIGS. 4A-4E illustrate various perspective views of an aperture configured in accordance with embodiments of the present invention.

FIG. 5 illustrates a side view of light rays and their interactions with the reflector and lenses of an optical inspection system, in accordance with the design of the aperture of FIGS. 4A-4E.

FIG. 6 is a graph of root mean square (RMS) spot size as a function of field position, as used to design the aperture of FIGS. 4A-4E.

FIG. 7 is a graph illustrating a top view of the outline of an aperture edge, as calculated according to a position of minimum RMS spot size.

FIG. 8 is a graph illustrating a side view of the outline of an aperture edge, as calculated according to a position of minimum RMS spot size.

FIGS. 9A-9B illustrate graphs of a desired light intensity profile calculated for a circular 200 mm illumination area, according to embodiments of the present invention.

FIGS. 10A-10B illustrate graphs of a desired light intensity profile calculated for a circular 300 mm illumination area, according to embodiments of the present invention.

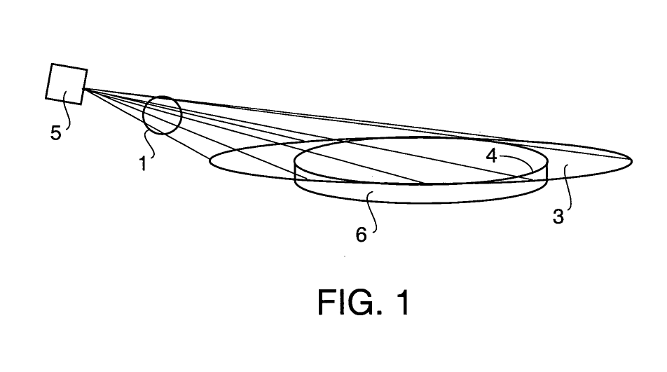

Like reference numerals refer to corresponding parts throughout the drawings.

### DETAILED DESCRIPTION OF EMBODIMENTS OF THE INVENTION

In one sense, the invention relates to the projection of a light field on a substrate, the light field having a uniform intensity across the substrate, as well as a predefined area with sharp edge cutoff. To illuminate a specific predefined area, an aperture is placed within a light beam path. This aperture has a specifically designed three-dimensional profile, so as to shape the light beam in a specific manner. When this shaped light beam is transmitted through the appropriate optics, its profile is altered so as to be projected onto the wafer as a circle (or any other desired shape) with sharp cutoff edges. The invention also includes methods of designing aperture profiles to produce any specific desired shape of the substrate illumination area with sharp edge cutoff. In this manner, given any predetermined shape of the area to be illuminated, the invention allows the design of an appropriate aperture for generating that shape, even when the light path must first be focused and/or reflected.

To illuminate this predefined area to a uniform intensity, an optical mask is also employed. This optical mask has a varying light attenuation across its surface, so as to impart a varying intensity to the light path. The combination of an aperture to shape the light path, combined with an optical mask to impart a varying light intensity to this shaped light path, allows for the generated light field to have a uniform intensity across the predefined area. That is, the aperture shapes the light path, and the optical mask spatially attenuates it, in specific manners so that the end result is a uniformly-intense light field that illuminates only a specific predefined area of the wafer. In this manner, wafers can be illuminated so as to avoid undesirable areas such as wafer edges, and so as to prevent over- or under-illumination.

While embodiments of the invention are explained in the context of optical inspection of a semiconductor wafer, the invention is not limited to this context. One of skill will realize that other embodiments of the invention can be employed in the illumination and inspection of any other substrate (and indeed, many other objects), such as a hard disk drive disk. The invention simply discloses the generation of a predefined, uniform-intensity light field upon an object. One of skill will also realize that still other embodiments of the invention can be employed to focus illumination in any form of optical inspection, such as dark ultraviolet, infrared, or visible light inspection. Furthermore, the invention can be employed to shape electromagnetic beams for any application that they may be required for. As an example, they can be employed to shape x-rays during x-ray imaging.

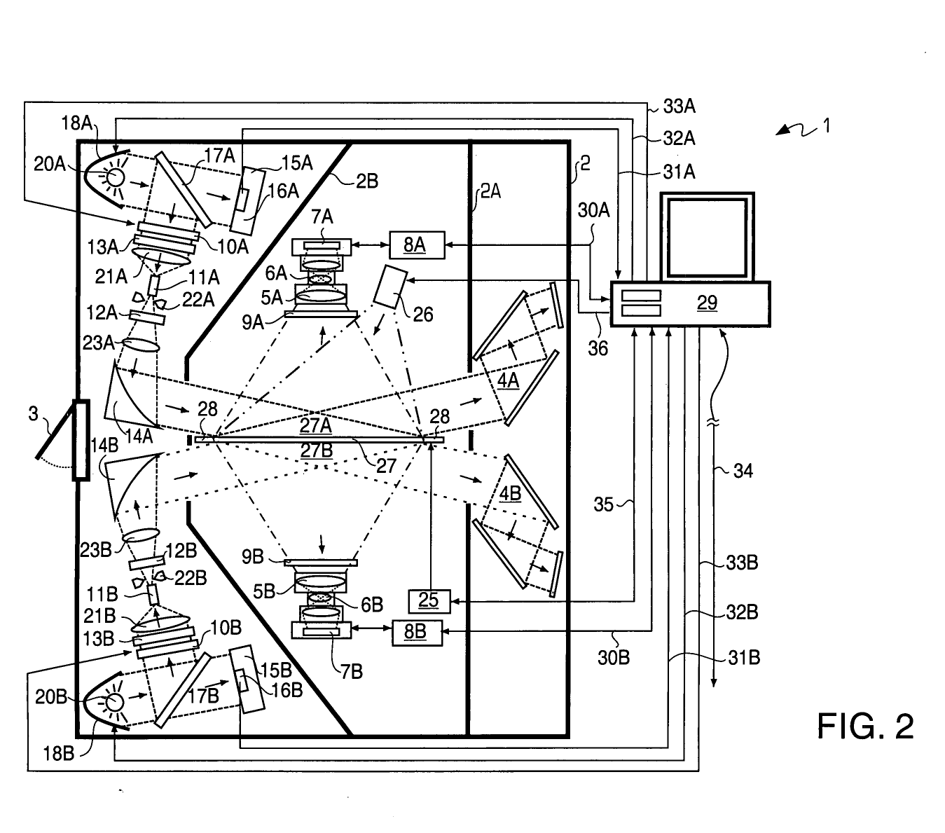

FIG. 2 illustrates an optical inspection system configured in accordance with embodiments of the present invention. The optical inspection system provides simultaneous illumination of the top and bottom surface of a substrate 27, although while features of the invention can be employed in this context, such need not be the case. Various features of the invention can be employed to shape light beams on one or two sides of the substrate 27, and the two-sided configuration of FIG. 2 is shown for purposes of convenience only. The scatter from scattering features that scatters light in the illuminated area is detected across the entire area simultaneously by high dynamic range and high precision array photodetectors. The scattering features may include, but are not limited to, defects in the substrate, scratches, pits, particles, device patterns and pattern anomalies, etched regions, polish roughness and texture on the surface of the substrate; embedded particles in films on a surface of the substrate and any aspect of the surface of the substrate that scatters light. In accordance with the invention, the light may include electromagnetic radiation energy from less than 200 nm in wavelength to more than 1100 nm in wavelength and preferably from deep ultraviolet electromagnetic radiation to visible electromagnetic radiation energy. Since each array photodetector pixel integrates scattered light individually, scatter signals can be acquired in parallel, thus significantly increasing measurement throughput. Because the whole substrate is illuminated and imaged simultaneously and the substrate is not in motion during the measurement, system-to-system matching, throughput, reliability, size and cost are greatly improved over existing commercial defect inspection systems. The elements of the system will be described generally with respect to FIG. 2. Certain elements of the system are then described in greater detail below.

The system may include an enclosure 2 that preferably may be light tight to keep unwanted light from entering into the enclosure. The internal surfaces of enclosure 2 are treated to minimize reflected light so as to reduce stray light getting into the collection/imaging optics of the photodetectors. Another source of background stray light in the enclosure is Rayleigh scatter caused by the illumination light beam interacting with air and other molecules inside the enclosure. Scatter from particles much smaller than the wavelength of the illuminating light is Rayleigh scatter. For air, the dominant scattering particles are suspended particulates and water vapor. In a semiconductor fabrication, particulate levels are virtually zero, so water vapor is the major contributor. Rayleigh scatter can be virtually eliminated by drying the air in the measurement enclosure, filling the enclosure with a gas such as dry nitrogen or optimally evacuating the enclosure to less than a few torr. The enclosure may also be vacuum tight to maintain a vacuum within the enclosure for integration onto a vacuum chamber and for reduction of Rayleigh scatter. The enclosure may also be gas tight to maintain a controlled pre-determined gas mixture within the enclosure primarily for reduction of Rayleigh scatter. The enclosure may further include bulkheads 2A, 2B separating beam dump optics and illumination optics respectively from the measurement region to further reduce stray light. The system may further include a load port 3, which permits a substrate 27 (having one or more surfaces to be inspected and analyzed) to be placed into and removed from the enclosure 2. The load port 3 is located such that the substrate can be loaded/unloaded without interfering with any components inside the enclosure. The load port 3 may include a light tight door that can be opened to provide access to the inside of the enclosure. If the enclosure is vacuum tight, then the load port 3 may also be vacuum tight. If the enclosure is gas tight, then the load port 3 may also be gas tight.

The system may further include one or more beam dumps (such as a substrate backside beam dump 4B and a substrate frontside beam dump 4A as shown in FIG. 2) that are positioned as shown in FIG. 2 opposite from the respective illumination light energy source. The beam dumps absorb the specular light energy reflected off of frontside 27A and backside 27B of the substrate 27 to reduce the unwanted light within the enclosure. The beam dumps absorb virtually all the light that impinges on them to minimize stray light to a pair of high dynamic range and high precision scatter photodetectors 7A, 7B. Beam dumps may be implemented with very dark light absorbing plates, such as used for welder's goggles, tilted so the incident light strikes the first glass plate between 30 and 60 degrees, the reflected light is directed to a second glass plate, and so on. The reflecting surface of the dark light absorbing plates should have a very smooth finish to minimize scatter. Any light that passes through the plates is so heavily attenuated that it is of no concern. The remaining beam reflected from the second dark glass plate impinges on a dark flat black surface roughly perpendicular to the beam, which is sufficient to fully absorb the remaining light. Minimizing stray light is desirable to allow detection of the weakest scatter by the detectors 7A, 7B. The positioning of the beam dump, detector, and light source shown in FIG. 2 may be changed without departing from the scope of the invention.

The system further comprises one or more photodetector imaging lenses (such as a frontside imaging lens 5A and a backside imaging lens 5B as shown in FIG. 2) that capture the light energy from the backside and frontside of the substrate, respectively, that is scattered by the topology on the substrate (including scattering features) on each surface of the substrate and image the scattered light energy onto the respective detector 7A, 7B. The light energy may also pass through polarizers (such as a frontside polarizer 9A and a backside polarizer 9B as shown in FIG. 2) that filter scatter according to the polarization orientation. By adjusting the image sensor polarizer axis perpendicular to the illumination polarization, the only light that passes to the detector is called cross-polarized light. Cross polarization filtering is a way to further reduce background scatter because scatter from some scattering features, such as particle scatter, causes preferential polarization rotation while surface scatter is more random and the random scatter will be blocked by the cross polarizer configuration. The invention may also be implemented without the polarizers. The system may further comprise one or more field lenses (such as a frontside field lens 6A and a backside field lens 6B as shown in FIG. 2) in combination with the respective imaging lenses which significantly increase the light energy imaged onto the photodetector as is well known. The invention may also be implemented without the field lenses. As used herein, the imaging lenses and the field lenses together may be referred to as light collection optics so that the system shown in FIG. 2 includes backside collection optics and frontside collection optics. In accordance with the invention, the frontside and backside collection optics light path may be folded using, for example, mirrors and the like.

The system may further comprise one or more high dynamic range and high precision photodetectors (such as a frontside photodetector 7A and a backside photodetector 7B as shown in FIG. 2), which detect the scattered light from each respective side of the substrate that is imaged onto the photodetector by the respective light collection optics. In a preferred embodiment, each photodetector may be a charge injection device (CID) photodetector array, which has very high dynamic range and very high precision and can image short wavelength light below 200 nm, which includes deep ultraviolet (DUV) light. The system further comprises one or more CID controllers (such as frontside CID controller 8A and backside CID controller 8B as shown in FIG. 2) that are connected to the respective CID array and may provide power, chip control and TEC control for the respective CID array. The controller's 8A, 8B may also each include analog to digital converters (digitizers) which convert the analog signals from the CID array pixels into digital signals. Furthermore, the controllers 8A, 8B may accept high level commands over a high-speed connection. As used herein, the frontside photodetector and the frontside controller may be referred to collectively as a frontside detector and the backside photodetector and the backside controller may be referred to collectively as a backside detector.

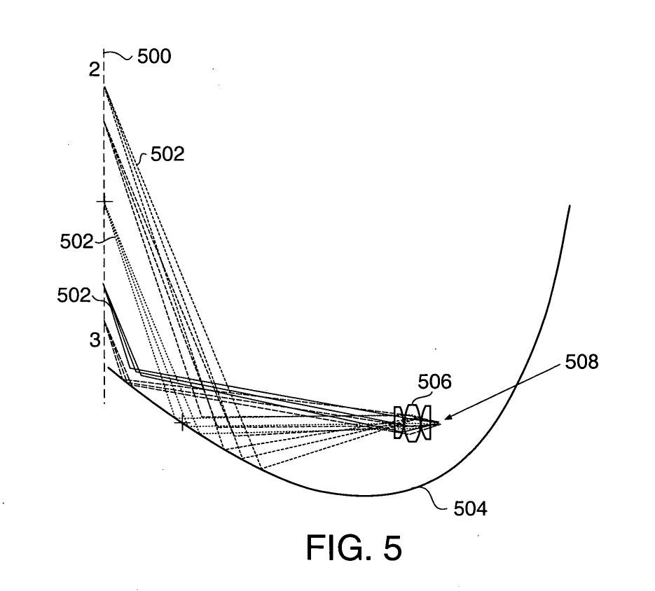

The system may further comprise a broadband bright field light energy source 26 as shown in FIG. 2, although the invention does not necessarily require the use of such an energy source 26. The bright field source illuminates the entire frontside of the substrate for viewing by the frontside detector. The bright field source can be turned off and on by the control computer using control line 36. This illumination, in conjunction with the frontside photodetector 5A-7A, may be used for substrate alignment and to detect if a substrate is loaded onto the wafer substrate handler 28 as shown in FIG. 5, described further below. This illumination, in conjunction with the frontside photodetector 5A-7A, may be used for substrate identification by detecting bar codes and/or alphanumeric characters laser scribed on the substrate. This illumination may also be used for brightfield scattering feature inspection using the high dynamic range and high precision photodetector 5A-7A.

The system may further comprise one or more dark field broadband light energy sources (such as a frontside broadband light source 20A and a backside broadband light source 20B as shown in FIG. 2) that direct broadband light (light having a wide range of wavelengths) towards the frontside 27A of the substrate 27 and the backside 27B of a substrate 27, respectively. Broadband light sources may be, for example, Xenon or Mercury vapor, Metal Halide, a combination of Xenon and Mercury vapor or a combination of other gaseous materials or sources such as combining light from Tungsten and Deuterium sources which results in a broad wavelength spectrum with reasonable DUV content. The source could also be a combination of one or more lasers or light emitting diodes (LEDs). The preferred light energy source is a Xenon high-pressure arc, which emits light from below 200 nm to well past 1100 nm. The system may further comprise one or more light source reflectors (such as a frontside source reflector 18A and a backside source reflector 18B as shown in FIG. 2) that receive the light energy output that would normally be lost from the source and direct the light energy towards respective mirrors, which can be dichroic mirrors 17A, 17B.

The dichroic mirror (a frontside dichroic mirror 17A and a backside dichroic mirror 17B as shown in FIG. 2) preferably reflects DUV through visible wavelengths and transmits longer infrared (IR) wavelengths. The dichroic mirror acts as an effective wavelength separator so that IR wavelength light does not impinge on the substrate 27. The dichroic mirror transmits IR light that is collected and absorbed by source beam dumps (such as a frontside source beam dump 15A and a backside source beam dump 15B as shown in FIG. 2). A portion of the IR light is also directed to source light intensity sensors (such as a source light intensity sensor 16A and a source light intensity sensor 16B as shown in FIG. 2). The source light intensity sensors provide feedback to the system regarding light intensity of the broadband light source through control lines 31a and 31b. The source light intensity sensors are needed especially for differential measurements to normalize illumination intensity variations but also provides other information, for example, to allow prediction of the remaining lifetime of the source. Also, scatter signals can be normalized by the source light intensity to correct for variation in the source light output over time.

The dichroic mirror also reflects the DUV through visible light onto one or more light beam shutters (such as a frontside shutter 10A and a backside shutter 10B as shown in FIG. 2) that receive the light energy output from the dichroic mirrors and either pass or block the light. The shutters are controlled by control lines 33A, 33B respectively. The light energy exiting the shutters impinges on one or more optical band pass filters (such as a frontside band pass filters 13A and backside band pass filters 13B as shown in FIG. 2). These band pass filters allow the illumination to the substrate surface to be limited in wavelength range. By limiting the illumination wavelength range, wavelength dependent particle scatter can be analyzed to discriminate material properties and particle sizes. The invention may also be implemented without the band pass filters.

The output of the band pass filters passes to a focusing lens assembly (such as a frontside focusing lens assembly 21A and a backside focusing lens assembly 21B as shown in FIG. 2). The focusing lens assembly has good transmission in the DUV, is optimized to efficiently collect the light from the CERMAX source and focuses the light at the optimum numerical aperture for the light beam homogenizer. The output of the focusing lens assembly is focused into a respective light beam homogenizer (such as a frontside light beam homogenizer 11A and a backside light beam homogenizer 11B as shown in FIG. 2). The homogenizers improve the uniformity (both the spectral uniformity and the time-dependent variations in the light generated over a period of time) of the light energy directed onto the front and backsides of the substrate 27,. The light beam homogenizers are thus well known optical components used to generate light beams of uniform spectral distribution and time-independent intensity, and often used with arc sources. The homogenizers are made from high quality optical quartz and have good DUV transmission. The homogenizers could also be a hollow structure with highly polished sides or a collection of closely packed micro-lenses called a “fly's eye integrator”. The light energy exiting the homogenizers impinges on one or more polarizers (such as a frontside polarizer 12A and backside polarizer 12B as shown in FIG. 2) that affect the light energy such that the light exiting the polarizers is uniformly polarized. The polarizers also have good DUV transmission. Wire grid polarizers are an example of a polarizer with good broadband transmission. The invention may also be implemented without the polarizers.

The light energy exiting the homogenizers impinges on beam conditioning apertures (such as frontside beam conditioning apertures 22A and a backside beam conditioning apertures 22B as shown in FIG. 2). The beam conditioning apertures 22A, 22B shape the beam so the transmitted aperture shape in combination with frontside image relay lens 23A and backside image relay lens 23B and frontside parabolic section mirror 14A and backside parabolic section mirror 14B produces the desired sharp edge illumination onto the substrate 27. The apertures 22A, 22B are tilted with respect to the illumination axis and have a three-dimensional contour to ensure the aperture edges are imaged sharply onto wafer 27.

After conditioning by the apertures 22A, 22B, the light energy exiting the apertures impinges on one or more polarizers (such as a frontside polarizer 12A and backside polarizer 12B as shown in FIG. 2) that affect the light energy such that the light exiting the polarizers is uniformly polarized. The polarizers also have good DUV transmission. Wire grid polarizers are an example of a polarizer with good broadband transmission. The invention may also be implemented without the polarizers.

After having passed through front and backside polarizers 12A, 12B light impinges on one or more image relay lenses (such as a frontside image relay lens 23A and a backside image relay lens 23B as shown in FIG. 2). The image relay lenses relay the three-dimensional aperture profile from apertures 22A, 22B in combination with mirrors 14A, 14B in such a way that the desired sharp edge image is projected and an angle onto the plane of the substrate 27. The image relay lenses have good transmission from visible through DUV wavelengths.

After having passed through front and backside image relay lenses 23A, 23B light impinges on one or more parabolic section mirrors (such as a frontside parabolic section mirror 14A and a backside parabolic section mirror 14B as shown in FIG. 2). The parabolic surfaces of the parabolic section mirrors convert the diverging beam incident on the mirrors to a collimated beam. In order to shape the collimated light reflected from the parabolic section mirrors 14A, 14B to illuminate only the (circular) substrate, the beam directed onto the mirrors is appropriately shaped. For example, in one embodiment described below, the beam shape at the mirrors is roughly semicircular in shape. The beam conditioning apertures 22A, 22B are shaped to produce this desired beam shape. The homogenizer also can have a pentagonal cross section, which helps increase the amount of light passed.

As used herein, the light energy source, the source reflector, the shutter, the dichroic mirror, the light beam homogenizer, the polarizer, the light conditioning lens assembly, the beam conditioning apertures and the projection mirror, individually and in various combinations, may be referred to as an illumination system. The output of the illumination system falls relatively uniformly, collimated and with sharp edges onto substrate front and backsides 27A, 27B respectively, of the substrate as shown. In accordance with the invention, the optics and the light path of the frontside and backside illumination system may be folded using, for example, mirrors and the like.

Thus, in the system shown in FIG. 2, there may be a backside illumination system that directs light energy towards the backside of the substrate and a frontside illumination system that directs light energy towards the frontside of the substrate. In accordance with the invention, the frontside and backside dark field illumination systems may be operated simultaneously so that the frontside and backside of the substrate are simultaneously illuminated and imaged. The frontside dark field illumination, in conjunction with the frontside photodetector 5A-7A, may also be used for substrate identification by detecting bar codes and/or alphanumeric characters laser scribed on the substrate. The frontside and backside illumination systems may also be used for darkfield scattering feature inspection using the high dynamic range and high precision photodetector 5A-7A.

The system may further comprise a substrate handler motor/controller 25, which controls the operation and motion of a substrate handler 28 that aligns the substrate prior to substrate measurement. Once the substrate has been loaded onto the substrate handler 28, the orientation of the substrate may be aided by illuminating the entire frontside of the substrate with the brightfield source 26. The frontside photodetector images the whole substrate including the edges. A wafer substrate with a notch or flat will have a distinct edge pattern and the bright field image can be processed to determine the orientation of the notch or flat as well as substrate center. Once the notch or flat is found, the substrate handler may orient the substrate to a pre-defined orientation if the substrate has not already been externally pre-aligned. The substrate may be pre-aligned before the substrate is loaded, in which case, the substrate handler 28 does not need to orient the substrate. If the substrate has identification marks, such as engraved alpha-numeric characters or a bar code, then the substrate would first be oriented to a position to enhance the identification marks in the frontside detector image using either darkfield illumination from the broadband source discussed above, the brightfield source 26 or both. The high dynamic range and high precision detector will provide robust images enabling substrate identification detection for high contrast substrate surfaces. The resulting frontside detector image can be processed using known optical character recognition (OCR) or Barcode detection software algorithms.

Once the substrate identification has been determined, the substrate can be rotated to the measurement orientation. The OCR or barcode detection are optional processes. Since the system images both sides and the edges of the substrate simultaneously, the handler does not interfere significantly with these inspections. Interference with the illumination beams is minimized with an edge gripping substrate handler. Repeatable substrate orientation with respect to the substrate notch or flat is needed for differential measurements and to minimize periodic pattern scatter to the frontside and backside detectors. The substrate can be oriented either by the substrate handler or by an external substrate pre-aligner before the substrate is loaded. If the substrate is pre-aligned before loading, then the substrate handler can be an edge gripper mechanism only without rotation capability. The system may further include control lines 35 that connect the substrate handler controller to a control computer 29 that controls the operation of the substrate handler.

The control computer 29 may further comprise a database (not shown) for storing the measurement and inspection results as well as other information such as images of the substrate scatter. The control computer 29 also controls the other operations of the other elements of the optical inspection system in accordance with the invention. For example, the system may include control lines 30A, 30B which connect the control computer to the CID controllers 8A, 8B so that the computer controls the operation of the CID controllers and receives the digital signals from the CID controller corresponding to the outputs from the respective CID array high dynamic range and high precision detectors. The system may further include control lines 32A, 32B which connect the control computer to the light energy sources 20A, 20B and control the operation of those light energy sources. The system may further include control lines 32A, 32B that connect the control computer to the light shutters 10A, 10B and control the operation of those shutters. The control computer may also have an interface line 34 which connects to other computer systems within a wafer substrate fabrication plant or to a computer network so that the control computer may output data to the computer network or wafer substrate fabrication system and may receive instructions. As is well known, the control computer may have the typical computer components such as one or more CPUs, persistent storage devices (such as a hard disk drive, optical drive, etc), memory (such as DRAM or SRAM) and input/output devices (such as a display, a printer, a keyboard and a mouse) which permits a user to interact with the computer system. These components of the control computer are not shown.

To control the operation of the optical inspection system in accordance with the invention, the control computer may include one or more software modules/pieces of software that are executed by the CPU. These modules may cause the control computer to control the elements of the optical inspection system connected to the control computer. For example, one software module may monitor the temperature of each CID array through the CID controller and may provide control commands to the CID controller to maintain the temperature of the CID array. As another example, another software module being executed by the CPU of the control computer may control the movement and operation of the substrate handler. It is also possible for the control computer functions to be implemented within the CID controllers 8A, 8B and not require separate system controller hardware.

In operation, a substrate is placed into the system through the load port 3. The substrate is placed into the substrate handler 28, which then moves the substrate from a loading position to a substrate inspection position (shown in FIG. 2). Next, the front and backside shutters are opened (under control of the control computer) to produce light that simultaneously strikes the backside and frontside of the substrate at an angle other than normal incidence. In accordance with the invention, the entire frontside and backside surface of the substrate are illuminated. The light energy directed at the backside of the substrate is scattered by scattering features on the backside of the substrate and the light energy directed at the frontside of the substrate is scattered by scattering features on the frontside of the substrate. Light scattered by backside scattering features is gathered by the backside collection optics and detected by the backside high dynamic range and high precision detector. Similarly, the light scattered by frontside scattering features are gathered by the frontside collection optics and detected by the frontside detector. In this manner, scattering features on the frontside and backside of the substrate 27A, 27B are simultaneously imaged and detected. The results detected by the photodetectors are converted into digital signals and are forwarded to the control computer. The control computer may include one or more pieces of analysis software that analyze the digital signals from the photodetectors and generate results and data.

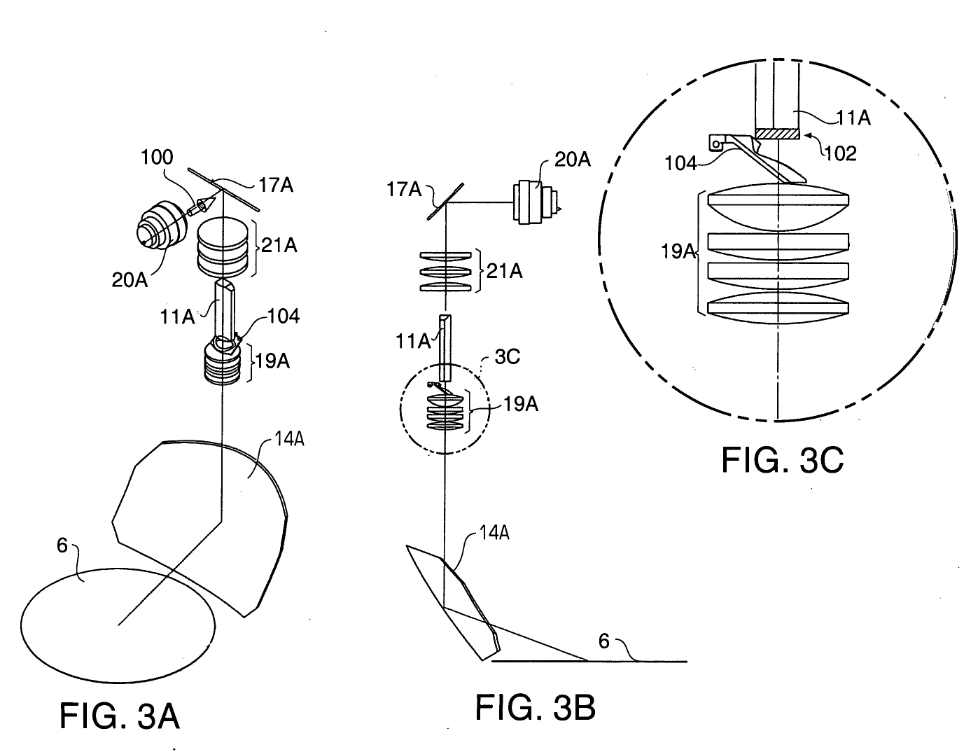

FIGS. 3A-3B illustrate diagrammatic isometric and side views, respectively, of further details of the illumination system within the optical inspection system of FIG. 2, including an aperture configured in accordance with embodiments of the present invention. For simplicity, only a single illumination system is shown. However, as can be seen from FIG. 2, two such systems may be employed simultaneously. In the illumination system, the light source 20A emits a light beam 100 that illuminates a path as shown. The light beam 100 reflects from the dichroic mirror 17A and onto focusing lenses 21A, where the light is focused and transmitted to the homogenizer 11A. The homogenizer 11A generates a uniform spectral distribution within the light beam 100, as is known. From the homogenizer 11A, the light beam 100 passes through a mask 102, shown in FIG. 3C either attached in known fashion to the end of the homogenizer 11A if it is an attenuating mask, or if it is a scattering mask, ground into the output face of the homogenizer 11A. The mask 102 may be an optical attenuator having a metallic oxide coating of a varying thickness, where the thickness is varied so as to impart a predefined, varying cross-sectional intensity profile to the light beam 100.

Once the light beam passes through the mask 102, it is transmitted to an aperture 104, which may be simply an optically opaque body having an opening with a specially designed three dimensional profile. The aperture generates light (or other form of radiation) having a predefined profile, and may be implemented in various manners. The opaque body deflects and/or absorbs a portion of the light beam 100, while the profile of the opening passes a predefined, shaped portion of the light beam 100. In one embodiment of the aperture for the optical inspection system of FIG. 2, this shape is designed to project a circle, or any other predetermined shape of light field, onto the wafer 6 after conditioning/focusing by the lenses 23A and subsequent reflection from the reflector 14A. The shape of the aperture, coupled with the specific cross-sectional intensity profile imparted by the mask 102, acts to project a light field of a predetermined shape, and a uniform intensity, upon the wafer 6.

It should be noted that certain items in the illumination system of FIG. 2 have been omitted from FIGS. 3A-3C for the sake of clarity. However, these items can still be employed by various embodiments of the invention. For example, the shutter 10A and polarizer 12A have been omitted from FIGS. 3A-3C, but can still be placed within the light beam 100. Also, only a single aperture 104 is shown, and the aperture 104 is shown upstream from the light conditioning lenses 23A instead of downstream, as in FIG. 2. In a preferred embodiment, a single aperture 104 is employed upstream of the lenses 23A, but the embodiment of FIG. 2, namely multiple apertures 22A downstream from the lenses 23A, is also contemplated by the invention.

One of skill will realize that at least two aspects of the invention exist: 1) the three-dimensional profile of the aperture, designed to properly shape the light beam 100, and 2) the selective masking of the light beam to impart a specific intensity profile to the shaped light beam 100. In many embodiments, the former ensures that the light field projected on the wafer 6 is of the correct size and shape and has sharp edges, while the latter ensures that the projected light field is of a uniform intensity. While it is often preferable to include both aspects of the invention, such need not necessarily be the case. For instance, the invention contemplates embodiments in which only the aperture is employed to shape the light beam, without masking. This is often possible when the ratio of the peak light beam intensity to its lowest intensity is less than approximately 3:1. The aperture profile and its design are addressed first, followed by the masking of the light beam.

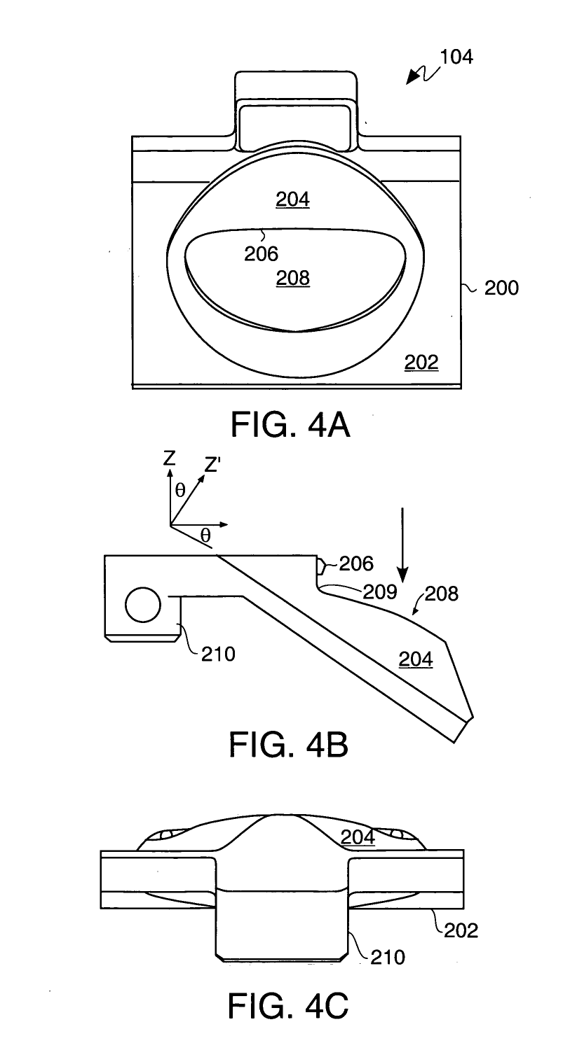

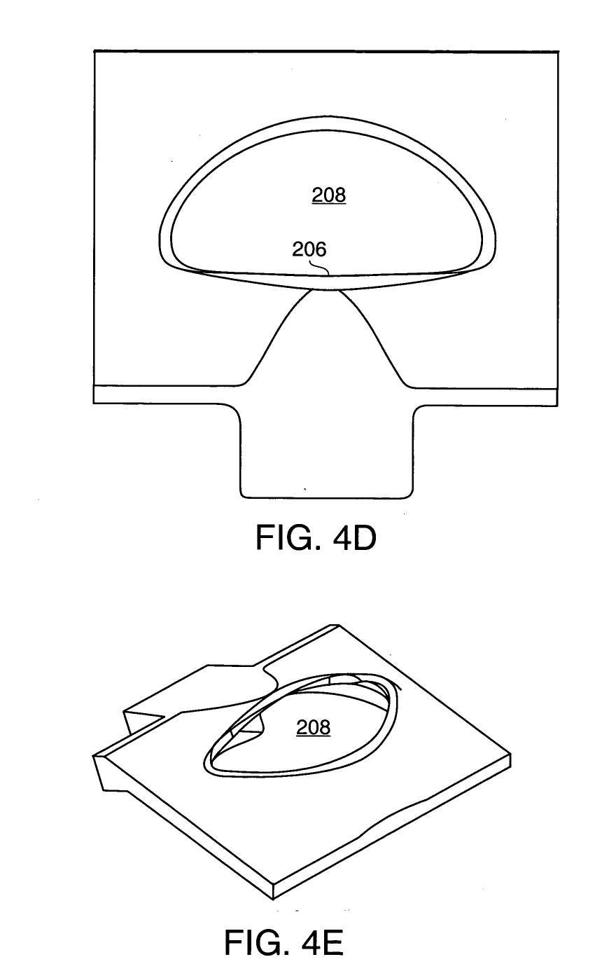

FIGS. 4A-4E illustrate various perspective views of the aperture 104 as configured in accordance with embodiments of the present invention. The aperture of FIGS. 4A-4E is configured in one embodiment shown in FIG. 2 to impart a circular light field upon the wafer 6. The invention is, however, not limited to this specific shape, and contemplates other configurations of the aperture, as designed by the methods described herein. The aperture 104 has an optically opaque body 200 that has a flat portion 202 and a raised portion 204. The raised portion 204 has a hole 208 or opening cut into it, with a three-dimensional outline or profile 206 as shown. In one embodiment, the profile 206 of the opening 208 is generally semicircular in shape when viewed along the Z-axis, as shown in FIG. 4A. However, it should be observed that this semicircular shape is simply a two-dimensional projection of a three-dimensional shape. This three-dimensional shape can be more clearly observed in FIG. 4B, which is a side view of the aperture 104 and the profile 206 of the hole 208. Viewed from the side, the profile 206 has an arcuate shape that, when viewed from left to right in FIG. 4B, dips sharply toward the body 200 to create a depression 209, then raises gradually away from the body 200. The remaining views of FIGS. 4C-4E illustrate various perspective views so as to more fully illustrate the shape of the profile 206 for the optical inspection system of FIG. 2 to generate a circularly-shaped beam that illuminates the substrate 6.

In operation, the opaque body 200 is attached to a portion of the optical inspection system, possibly via features such as a screw hole in a flange 210. This positions the body 200 securely within the light path, at a prescribed incidence angle ⊖ as shown. When positioned within the light path in this manner, the light beam 100 intersects the opaque body 200 along the direction shown by the arrow in FIG. 4B. The opaque body 200 thus acts as a filter, blocking a portion of the light beam 100 while passing another portion through the hole 208. The hole 208 is specifically shaped so that, when oriented at the angle ⊖, a shaped light beam 100 of a certain shape is generated. This shape, when reflected off the parabolic reflector 14A in the embodiment of FIG. 2, is projected onto the wafer 6 as a circle. Different shapes of the profile 206, and different orientations ⊖, can produce different predetermined shapes as desired.

It can be seen that certain elements of the opaque body 200 are not central to the invention, and can vary while still remaining within its scope. For example, while the geometry of the profile 206 must be specified, the geometry of the remainder of the opaque body 200 can vary significantly, so long as it still acts to shape a light beam. The body 200 can be made of anodized aluminum, however the invention contemplates the use of any material suitable for shaping a light beam and withstanding the environment of an inspection chamber. While the opaque body 200 partly shapes the light beam due to its opaque qualities, the invention contemplates the shaping of light beams in other manners. For example, the body 200 can be designed as a reflective body that reflects portions of the light beam, or as a transparent refractive body that refracts portions of the light beam away from the substrate 6 and the remainder of the light path 100.

It can also be seen that the shaping of the illuminated area is accomplished, in many embodiments, mostly by the design of the three-dimensional profile 206. FIG. 5 conceptually illustrates a method of designing the profile 206. The shape of the three-dimensional profile 206 can be determined by first specifying an area 500 of the wafer 6 that is to be illuminated (in this case, a circle is desired, which appears as a vertical line in this cross-sectional illustration). This area can be any size and any shape. Once this is specified, a uniform distribution of light rays 502 is traced back from the predefined area, off the reflector 504, and through the lenses 506. The shape of the reflector 504 and the optical properties of the lenses 506 being known, the paths of the light rays 502 can be calculated according to known optical principles. Also according to known optical principles, for each point of origin of the light rays 502, the three-dimensional surface 508 representing the points of best focus is determined. That is, the light rays 502, projected back through the lenses 506, form a three-dimensional surface 508 of best focus. The geometry of this surface 508 varies according to angular position along the wafer 6. Accordingly, the size of the three-dimensional surface 508 is determined as a function of angular position along the wafer 6, and the minimum size surface (representing the sharpest focus) determines the optimum shape of the aperture profile 206.

It can be seen that any predefined area 500 can be subjected to these aperture design methods. That is, for any known predefined shape of the area 500, the above described methods can be employed to determine a three dimensional aperture profile 206 that will result in a light field of that shape, so long as the properties of the intervening optics (i.e., reflector geometry, lens optics, etc.) are known. Thus, while the invention discloses a profile 206 capable of generating a circular light field upon the wafer 6, the invention is not so limited. Rather, the invention discloses the design of, as well as apertures having, profiles capable of generating an arbitrarily shaped light field upon a wafer/substrate 6.

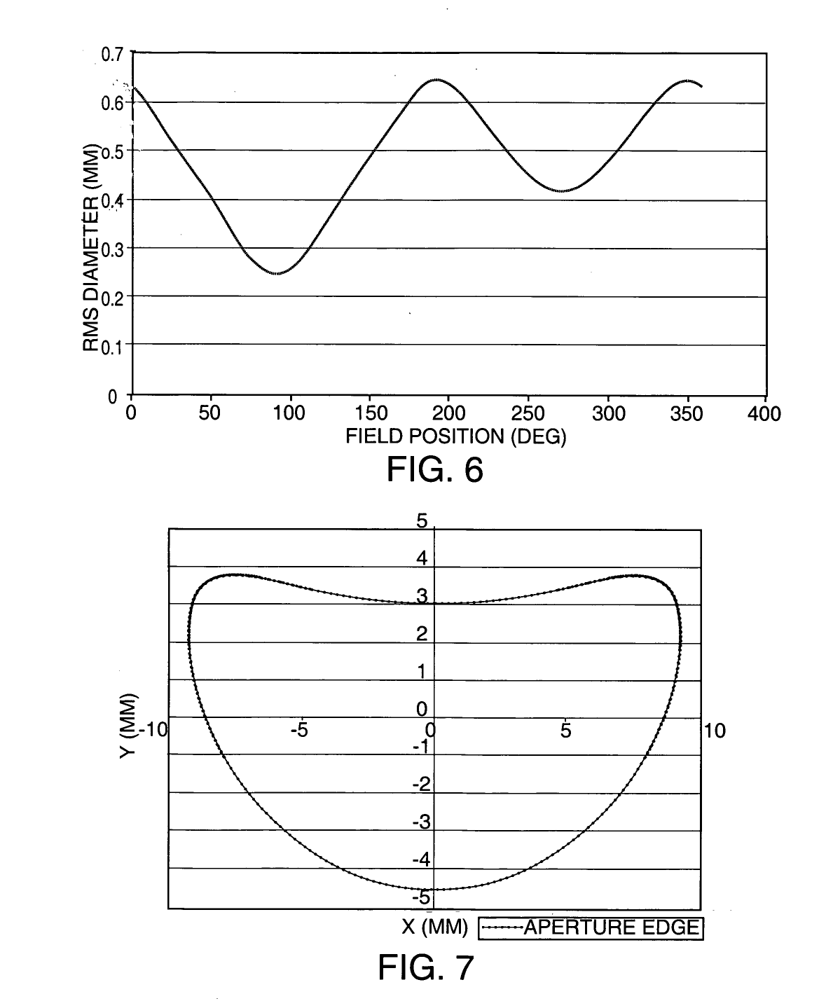

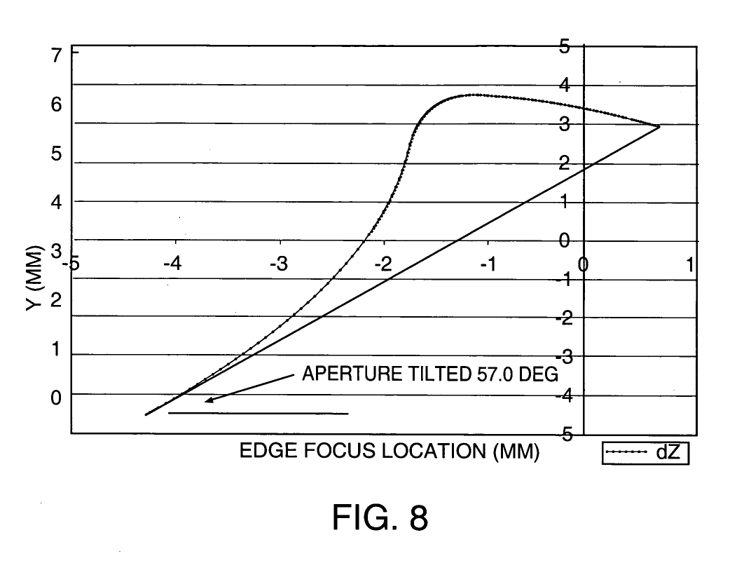

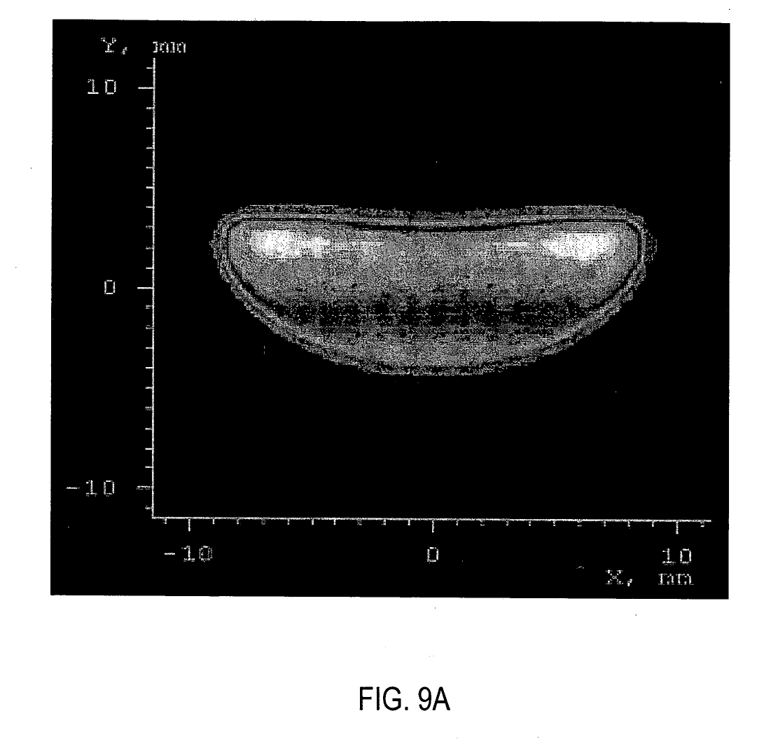

FIGS. 6-8 illustrate further details of the determination of profile 206. Once the region 508 is analyzed to determine the surface outlined by the various light rays 502, light rays 502 are traced back to determine the three-dimensional surfaces 508 of best focus, as a function of position along thee wafer. That is, the light rays 502 are traced back to determine the three-dimensional “spot” where the light rays 502 converge after having traveled through the illumination system. The angular position determining the smallest such spot is found, and the shape of the spot is used as the shape of the profile 206. FIG. 6 illustrates one such graph, where RMS diameter is plotted as a function of field position, or angular position along the edge of the wafer 6. The minimum shown illustrates the field position at which RMS diameter is the smallest. The three-dimensional path corresponding to this minimum RMS diameter then becomes the profile 206, which can be plotted from the Z axis and from the side (corresponding to the view of FIG. 4B), as shown in FIGS. 7 and 8, respectively.

Note that the profile, while used to generate a two-dimensional projection, has a three-dimensional shape. For example, in this specific example, the profile 206 is effectively tiled at an angle of approximately 57 degrees from the vertical, or 33 degrees from the horizontal. The specific examples of FIGS. 6-8 also illustrate a profile 206 configured to project a circular light field of 200 mm in diameter upon a wafer, using a parabolic reflector 14A and lenses 23A. Here, the illumination system employs a lens triplet and parabolic mirror designed as an off-axis imaging system. The lens 23A triplet shown comprises fused silica lenses, or optical elements, with one bi-convex element placed back-to-back between planar-convex elements, a configuration known to minimize aberrations and provide for sharply-focused illumination. The curvature of each element is (where curved) the same in this embodiment, and the optical elements are coated with broad band anti-reflective coatings to increase transmission through the lenses 23A. Other elements and configurations can of course be employed. For example, systems for illuminating 300 mm wafers can employ four lens elements. Note also that while this specific configuration of predetermined shape, lens optics, and reflector geometry yields a profile with the geometry described above, the invention discloses a more general method of determining any such profile, having any geometry appropriate for generating a predetermined shape of light field. In other words, the invention does not limit itself to the geometry discussed above, but rather is capable of determining whatever profile shape is necessary to generate the predetermined shape.

The parabolic reflector 14A can be any reflector. However, for sharpness of focus, it is often desirable to employ a reflector whose reflective surface with a sag calculated according to:

$$Z = \frac{{Cr}^{2}}{1 + \sqrt{1 - ( 1 + k ) {C}^{2} {r}^{2}}} where {r}^{2} = {x}^{2} + {y}^{2}$$

Here, parabolic surfaces can be determined by setting k=−1. The parabolic reflector 14A can comprise any sufficiently reflective system compatible with environment of the chamber 2, but in the embodiment shown, the reflector has a metallic substrate with a reflective aluminum coating for reflecting ultraviolet light. The aluminum coating can itself be coated with a known protective layer to prevent oxidation.

The determination of the three-dimensional profile 206 having been described, attention now turns to a second aspect of the invention, the required intensity distribution of the light beam 100 and its determination. Returning to FIG. 5, a light field of uniform intensity can be simulated by tracing a uniform pattern of light rays 502 back from the predetermined area 500. When these light rays 502 are traced back and the profile 206 is determined, the distribution of light rays 502 within this profile 206 can also be calculated. The number of light rays per unit of area within this profile 206 indicates the intensity of light field required so as to produce a uniform intensity light field upon the area 500.

Once this intensity distribution is determined, a mask can be fabricated, according to known means, that will yield this intensity distribution when placed in the light path 100. In certain embodiments, the mask is fabricated as a step liner neutral density filter. Typically, this filter configuration employs a glass substrate coated with a spectrally flat, neutral density coating such as a metallic oxide. The coating is deposited in a series of steps in order to achieve a varying thickness, yielding the correct intensity distribution. Note that because the mask 102 can be a coated glass plate, it can be placed in a number of areas within the light path 100. For example, it can be attached to the profile 206 within the body 200, suspended within the light path 100 between the homogenizer 11A and the aperture body 200, or even coated onto the end of the homogenizer 11A. In other embodiments, the mask is fabricated as a variation in surface roughness of a glass substrate, such that greater roughness produces higher attenuation. Accordingly, the invention simply discloses an optical attenuator which can be any device or method employed to achieve the desired intensity distribution. This attenuator can take the form of a coating, a surface roughness variation, or any other configuration capable of employ by those of skill in the art.

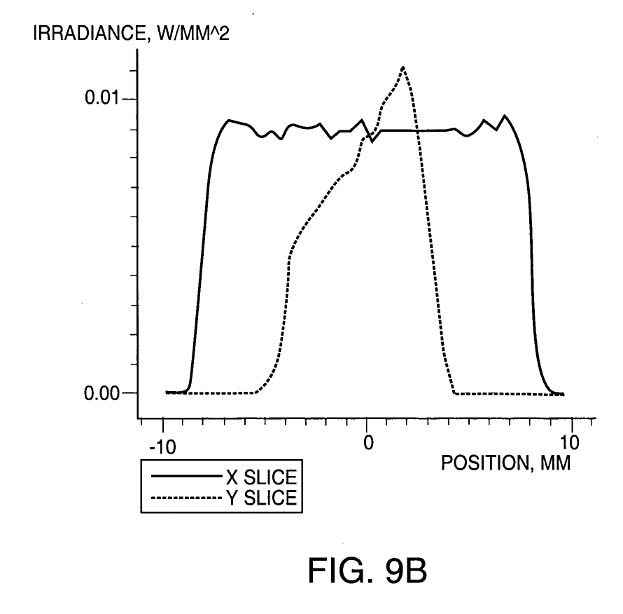

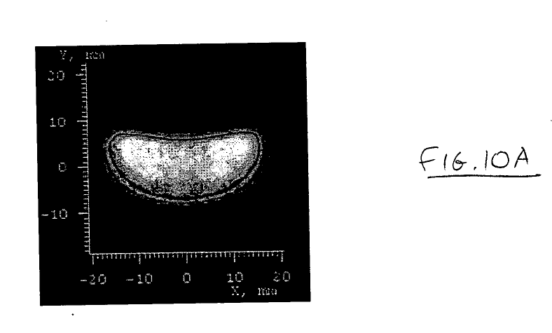

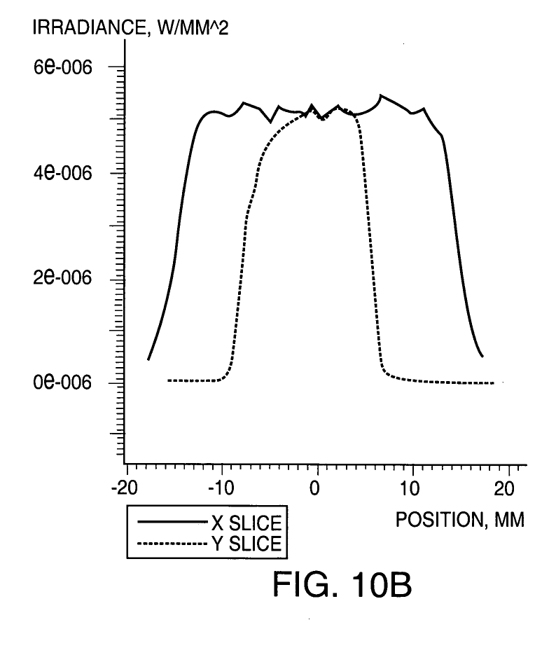

FIGS. 9A-9B illustrate charts of the intensity distribution for a 200 mm diameter predetermined area 500, with intensity values shown as a spatial distribution viewed perpendicular to the light path 100, and at the one-dimensional X=0 and Y=0 cross-sections of this distribution, respectively. These distributions are employed to determine the spatially-varying attenuation of the mask 102 required. Similarly, FIGS. 10A-10B illustrate corresponding charts for a 300 mm diameter predetermined area 500. Such a differing area 500 will yield a slightly different mask 102, according to the slightly differing intensity distribution shown in FIGS. 10A-10B. For instance, note that the intensity profile of the X=0 cross-section of FIG. 10A is much more even, and of lower overall magnitude, than the corresponding cross-section of FIG. 9A, which exhibits a sharp peak and greater overall magnitude. The invention encompasses the design of apertures and light intensity profiles having any shape and overall magnitude, so long as they result in the projection of uniform-intensity lighted areas having a predetermined shape.

It is worth reiterating that one of skill will realize that the invention encompasses other forms of inspection as well. For example, the aperture and mask can be employed to shape beams of any type of electromagnetic radiation, and not just light. Thus, the methods and apparatuses of the invention apply equally well to such inspection methods as DUV.

Also, it should be noted that the methods of the invention yield a shape and intensity distribution of a light profile, and not just an actual physical aperture and/or mask. Thus, the invention includes any apparatus that produces a light beam with the aforementioned cross-sectional shape and intensity distribution, and not just an aperture/mask. For example, a homogenizer 11A can be designed with a cross-sectional shape designed to project a light beam shaped according to the methods above, thus eliminating the need for a separate aperture body 200. Any specific configuration can be employed, so long as it results in the appropriately shaped light beam having the correct intensity distribution.

Finally, it should be noted that the invention encompasses the general design of a shaped light beam according to more general principles of ray optics, and not just according to the specific system shown. That is, the methods of the invention can be used, as will be apparent to one of skill in the art, to design shaped light beams for systems having different configurations, such as direct-illumination systems that do not utilize a reflector 504. The methods of the invention can also be used to configure light beams for projecting other shapes besides 200 mm and 300 mm circles, such as disk drive substrate illumination fields for illuminating disk drive substrates. These are commonly in the range of 25 to 99 mm in outer diameter.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. Many modifications and variations are possible in view of the above teachings. For example, the invention can include either the shaping of the light beam 100, the selective attenuation of the intensity of this light beam 100, or both. The embodiments were chosen and described in order to best explain the principles of the invention and its practical applications, to thereby enable others skilled in the art to best utilize the invention and various embodiments with various modifications as are suited to the particular use contemplated.

1. A substrate inspection system, comprising:
a radiation source configured to emit electromagnetic radiation along an illumination path so as to facilitate optical inspection of a surface of a substrate;
a reflector configured to reflect the illumination path onto the substrate; and
a filter placed in the illumination path between the radiation source and the reflector, the filter having an aperture shaped so as to pass a portion of the electromagnetic radiation along the illumination path on to the reflector so as to generate a predefined illuminated area on the surface of the substrate.

2. The optical inspection system of claim 1 further comprising a mask placed in the illumination path between the radiation source and the filter, the mask configured to selectively attenuate the electromagnetic radiation along a cross-sectional profile of the illumination path, so as to generate a uniform intensity of electromagnetic radiation over the predefined illuminated area on the surface of the substrate.

3. The optical inspection system of claim 2 wherein the mask is an optical attenuator.

4. The optical inspection system of claim 2 further comprising a homogenizer configured to facilitate the generation of a uniform spectral distribution and a time-independent distribution of the electromagnetic radiation across the cross-sectional profile, wherein the mask is coupled to the homogenizer.

5. The optical inspection system of claim 1 wherein the filter is placed at an incidence angle relative to the illumination path.

6. The optical inspection system of claim 1 wherein the filter has a raised portion, and wherein the aperture is located within the raised portion.

7. The optical inspection system of claim 6 wherein the aperture has a generally semicircular profile when viewed along an axis that intersects the illumination path at the incidence angle.

8. The optical inspection system of claim 1 further comprising one or more lenses placed in the illumination path between the filter and the reflector, the one or more lenses configured to focus the portion of the illumination path onto the reflector.

9. The optical inspection system of claim 1 wherein the reflector has a generally parabolic reflective surface.

10. The optical inspection system of claim 1 wherein the area is a generally circular area having a diameter of approximately 200 mm.

11. The optical inspection system of claim 1 wherein the area is a generally circular area having a diameter of approximately 300 mm.

12. The optical inspection system of claim 1 wherein the area has an outer diameter in the range of approximately 25 mm to approximately 95 mm.

13. The optical inspection system of claim 1 wherein the filter is a homogenizer configured to facilitate the generation of a uniform spectral distribution of the electromagnetic radiation across the cross-sectional profile, and wherein the aperture is a portion of the homogenizer shaped so as to pass the portion of the electromagnetic radiation along the illumination path, the portion having a uniform spectral distribution.

14. An apparatus for shaping an illumination path in an optical inspection system, comprising:
a body configured for placement within an illumination path of an optical inspection system and at an incidence angle relative to the illumination path, the body having:
a raised portion; and
an aperture within the raised portion, the aperture having a generally semicircular profile when viewed along an axis that intersects the illumination path at the incidence angle, the generally semicircular profile configured to shape the illumination path so as to facilitate the illumination of a predefined portion of a surface of a substrate when the opaque body is placed within the illumination path at the incidence angle.

15. The apparatus of claim 14:
wherein the generally semicircular profile has an upper portion including a diameter of the profile, and a lower portion opposite to the diameter and along the profile; and
wherein the aperture, when viewed along an axis perpendicular to the illumination path and perpendicular to an axis that intersects the illumination path at the incidence angle, has a generally arcuate profile extending from the lower portion, into the raised portion of the body to an intermediate point between the upper portion and the lower portion, and to the upper portion.

16. The apparatus of claim 14 wherein the predefined portion of the surface of the substrate has a generally circular area having a diameter of approximately 200 mm.

17. The apparatus of claim 14 wherein the predefined portion of the surface of the substrate has a generally circular area having a diameter of approximately 300 mm.

18. The apparatus of claim 14 wherein the predefined portion of the surface of the substrate has an outer diameter in the range of approximately 25 mm to approximately 95 mm.

19. An optical inspection system, comprising:
a light source configured to emit a light beam so as to facilitate optical inspection of a surface of a semiconductor wafer; and
means for shaping the light beam so as to illuminate a predefined area of the surface of the semiconductor wafer, the predefined area illuminated to a substantially uniform intensity.

20. The optical inspection system of claim 19 wherein the means for shaping further comprises means for selectively passing a portion of the light beam, and reflection means for directing the portion of the light beam onto the semiconductor wafer.

21. The optical inspection system of claim 20 wherein the means for selectively passing further includes aperture means for transmitting the portion of the light beam, and exclusion means for preventing the transmission of the remainder of the light beam.

22. The optical inspection system of claim 20 wherein the means for shaping further comprises means for varying the cross-sectional intensity of the light beam prior to a receiving of the light beam by the means for selectively passing.

23. The optical inspection system of claim 22 wherein the means for varying further comprises means for homogenizing the spectral distribution of the light beam, and means for selectively masking the homogenized light beam.

24. The optical inspection system of claim 23 wherein the reflection means further comprises parabolic reflection means for receiving the light beam, the light beam having a varying cross-sectional intensity, and shaping the light beam so as to illuminate the predefined area to a substantially uniform intensity.

25. The optical inspection system of claim 23 wherein the means for homogenizing further comprises means for homogenizing the intensity distribution of the light beam over a period of time.

26. A method of illuminating a substrate for inspection, comprising:
generating an electromagnetic radiation beam having a cross-sectional profile, the electromagnetic radiation beam having a nonuniform intensity across the cross-sectional profile;
reflecting the electromagnetic radiation beam so as to project an electromagnetic radiation field upon a substrate, the electromagnetic radiation field having a predetermined shape and a generally uniform intensity.

27. The method of claim 26 wherein the generating further comprises selectively attenuating the electromagnetic radiation beam so as to generate the nonuniform intensity across the cross-sectional profile.

28. The method of claim 27 wherein the selectively attenuating further comprises passing the electromagnetic radiation beam through a mask.

29. The method of claim 26 wherein the generating further comprises shaping the cross-sectional profile of the electromagnetic radiation beam so as to facilitate the projection of the predetermined shape.

30. The method of claim 29 wherein the shaping further comprises passing a portion of the electromagnetic radiation beam corresponding to the cross-sectional profile, and blocking the remainder of the electromagnetic radiation beam.

31. The method of claim 26 wherein the reflecting further comprises reflecting the electromagnetic radiation beam so as to project a generally circular electromagnetic radiation field upon the semiconductor wafer.

32. The method of claim 31 wherein the reflecting further comprises projecting an electromagnetic radiation field having a diameter of approximately 200 mm.

33. The method of claim 31 wherein the reflecting further comprises projecting an electromagnetic radiation field having a diameter of approximately 300 mm.

34. The method of claim 31 wherein the reflecting further comprises projecting an electromagnetic radiation field having an outer diameter in the range of approximately 25 mm to approximately 95 mm.
